(19) United States
(12) Patent Application Publication
(10) Pub. No.: US 2008/0265655 A1
(43) Pub. Date: Oct. 30, 2008

(54) Wheel with size indicating members

(76) Inventor: Ronald J. Doctor, Allenhurst, GA (US)

Correspondence Address: LITMAN LAW OFFICES, LTD., P.O. BOX 15035, CRYSTAL CITY STATION, ARLINGTON, VA, 22215-0035, US

(21) Appl. No.: 11/790,659

(22) Filed: Apr. 26, 2007

(51) Int. Cl. B60B 7/04

(52) U.S. Cl. 301/37.26

(57) ABSTRACT

The wheel with size indicating members is a wheel rim including a center section disposed concentrically inside it. A hub is disposed in an axial center of the center section. Size indicating members are disposed so that they are in rigid mechanical contact with the wheel rim and with some portion of the center section. The size indicating members hold the center section within a rotational center point of the wheel rim, and are configured to substantially indicate Arabic numerals representing the wheel size. Lug holes are radially disposed about the hub in the center section to provide mounting points for mounting the wheel on a vehicle. A cap removably attachable to the center section has indicia designed to complete missing components of the numerals so that the wheel size can be readily determined by observation.

### BACKGROUND OF THE INVENTION

1. Field of the Invention

The present invention relates to automobile wheels and, more particularly, to an automobile wheel having easily observable members that numerically indicate the size of the wheel.

2. Description of the Related Art

Many automobile owners desire an aesthetically pleasing and functional wheel design. As a result, various designs having a variety of ornamental markings and configurations have been marketed to the public. Notwithstanding these numerous offerings of a variety of wheel designs to the public, there remains the problem that the wheel size cannot readily be determined by observation without measurement. Wheel size is generally measured by the diameter of the rim and the width of the rim. For practical purposes, sometimes it is only necessary to know the diameter of the rim. While custom wheels may have the size stamped on the rim, often the size is in small lettering, becomes worn, or is located in a position that is not readily visible. Consequently, the consumer is generally advised to determine wheel size by deciphering the tire size, which is often confusing to consumers or difficult to read.

Thus, a wheel with size indicating members solving the aforementioned problems is desired.

### SUMMARY OF THE INVENTION

The wheel with size indicating members has a wheel rim with a center section (sometimes referred to as a spider) disposed concentrically inside it. A hub is disposed in an axial center of the center section. Size indicating members are disposed so that they are in rigid mechanical contact with an inner wall of the rim and with some portion of the center section. The size indicating members hold the center section within a rotational center point of the rim, and are configured to substantially indicate Arabic numerals representing the wheel diameter size. Lug holes are disposed in the center section radically about the hub to provide mounting points for mounting the wheel on a vehicle. A cap removably attachable to the center section has indicia designed to complete any missing components of the Arabic numerals so that the wheel size can be readily determined by observation.

These and other features of the present invention will become readily apparent upon further review of the following specification and drawings.

### BRIEF DESCRIPTION OF THE DRAWINGS

FIG. 1 is an environmental, perspective view of a wheel with size indicating members according to the present invention.

FIG. 2 is an exploded, perspective view of the wheel with size indicating members, according to the present invention.

FIG. 3 is a perspective view of a wheel with a first alternative embodiment of size indicia according to the present invention.

FIG. 4 is a perspective view of a wheel with a second alternative embodiment of size indicia according to the present invention.

FIG. 5 is an exploded, environmental perspective view of a wheel accessory according to the present invention having wheel size indicia formed thereon.

Similar reference characters denote corresponding features consistently throughout the attached drawings.

### DETAILED DESCRIPTION OF THE PREFERRED EMBODIMENTS

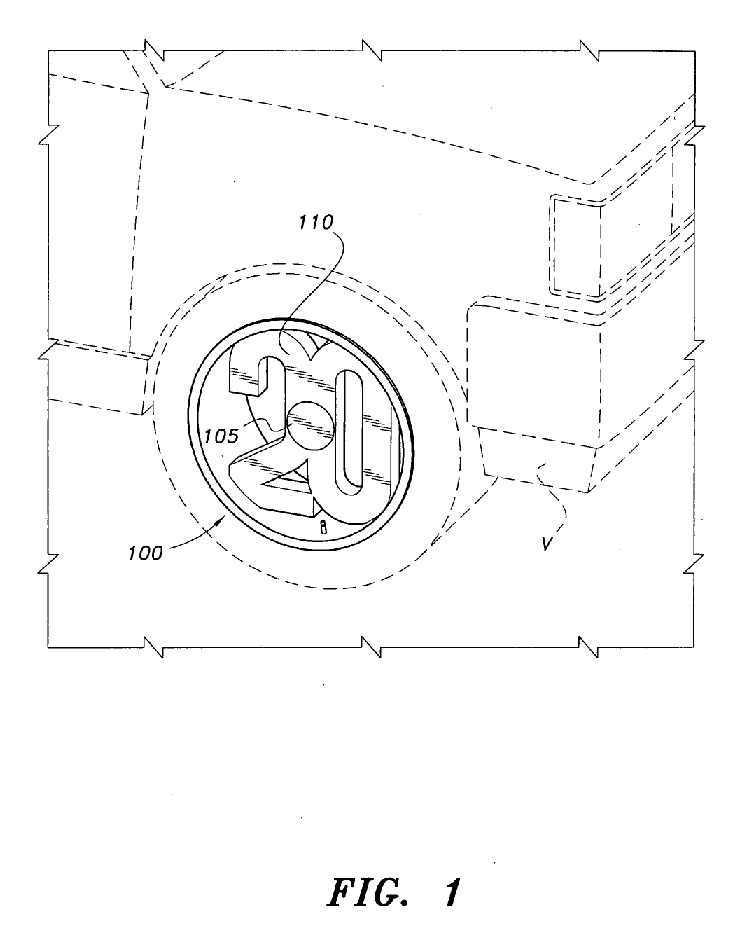

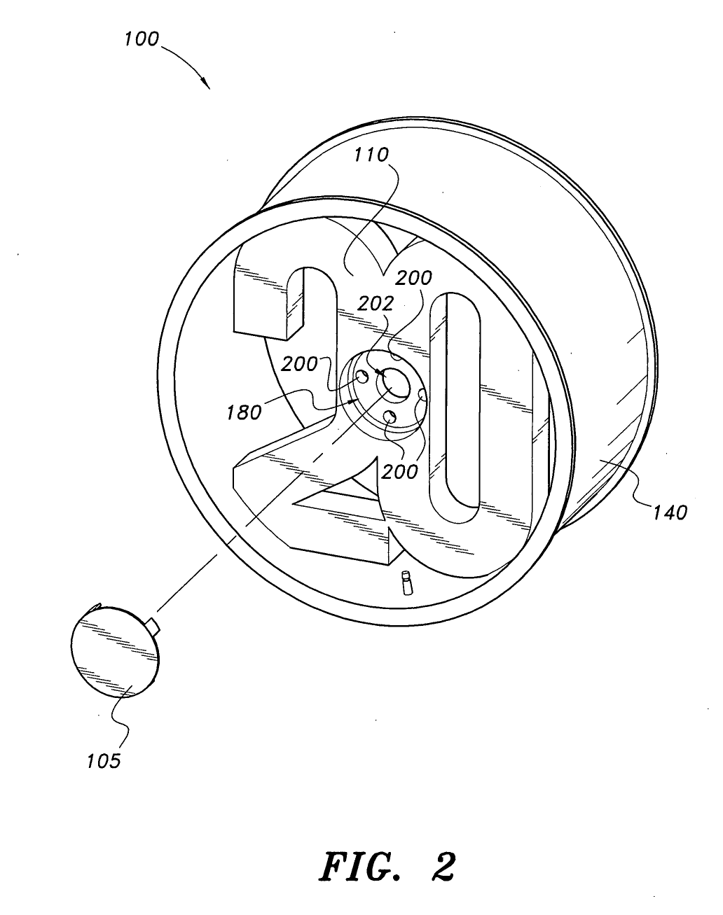

As shown in FIGS. 1 and 2, the present invention is a wheel 100 that includes a wheel rim 140 and a center section 180 concentrically inside the rim 140. Size indicating members are disposed so that they are in rigid mechanical contact with an inner wall of rim 140 and with some portion of the center section 180. The size indicating members 110 hold the center section 180 within a rotational center point of the wheel rim 140, and are configured to substantially indicate Arabic numerals representing the diameter of rim 140. As shown in FIGS. 1 and 2, the numerals “20” are formed from member 110 to show that the rim 140 is a 20″ diameter rim.

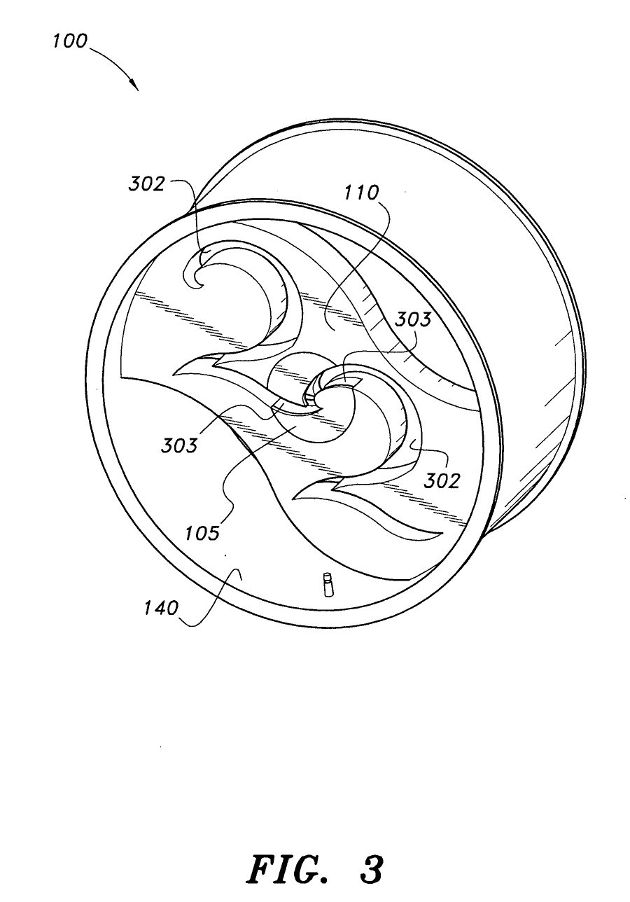

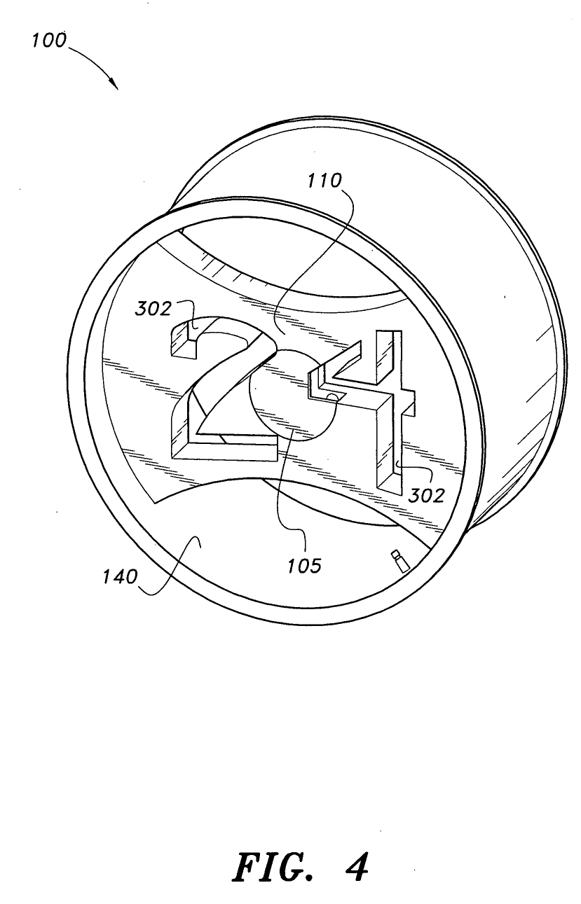

The members 110 may be shaped in the form of the numerals, or the numerals may be embossed on, embedded in, extruded from, decaled on, or otherwise disposed on the members 110. For example, as shown in FIGS. 3 and 4, the numerals may be formed from openings or recesses 302 in the member 110 that suggest a desired numeral pattern. FIG. 3 shows how a “22” is formed from the member 110 to indicate that wheel 100 is has a 22″ diameter rim 140. FIG. 4 shows how a “24” is formed from the member 110 to indicate that wheel 100 has a 24″ diameter rim 140.

Lug holes 200 are disposed in the center section 180 radially about hub 202 to provide attachment points when the wheel is mounted on a vehicle V. As shown in FIGS. 2-4, a cap 105 is removably attachable to the center section 180 and can have indicia 303 designed (extruded from, embossed in, decaled) on the cap 105 to complete any missing components of the Arabic numerals, which are substantially displayed on size indicating members 110 so that the wheel size can be readily determined by observation.

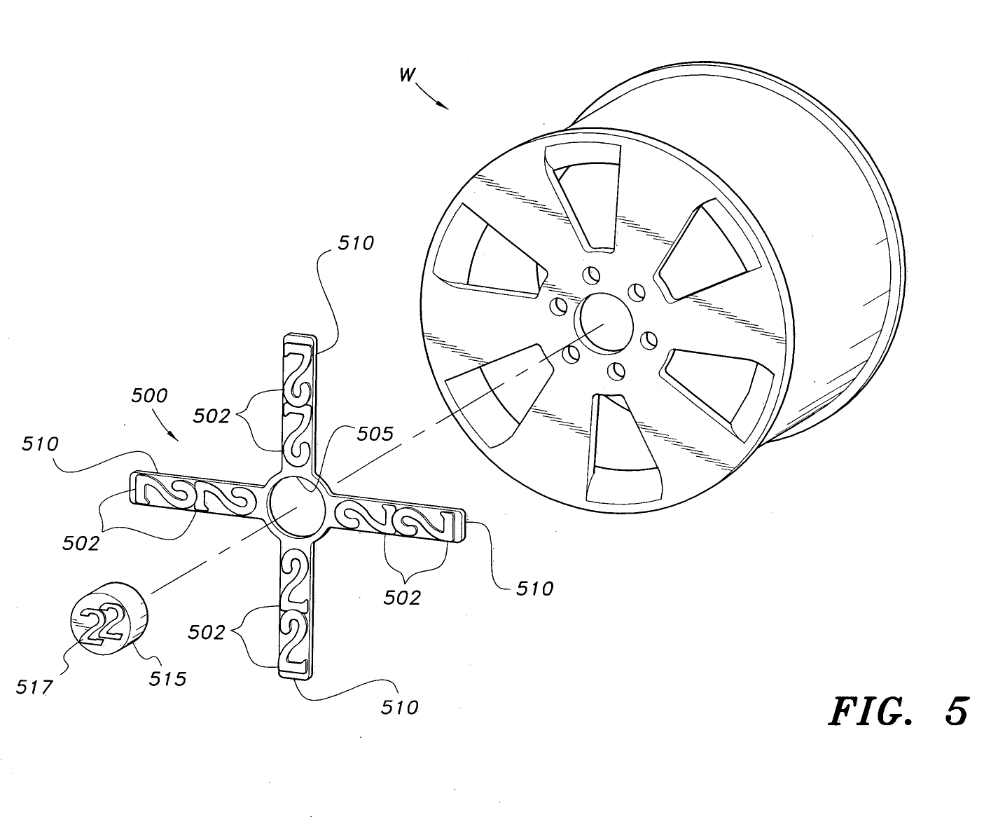

As shown in FIG. 5, in a third alternative embodiment, wheel size indicia 502 may be disposed on a member 500 attachable to a wheel W. The member 500 may have a central annular hub 505 and a plurality of spokes 510 extending therefrom. The central annular hub 505 of member 500 may snap to, or otherwise be attached to, the central hub portion of the wheel W. Moreover, inside circumferential portion of the central annular hub 505 may have bearings to enable the member 500 to spin freely, i.e., the member can be a wheel size indicating “spinner”.

It should be understood that member 500 is readily visible, and consequently the wheel size indicia 502 is readily visible, when the wheel W is in a normal configuration on a vehicle. The spokes 510 may extend to approximately the radial dimension of the wheel W, and, as shown in FIG. 5, the wheel size indicia 502 may be disposed on the spokes 510 of member 500. Spokes 510 need not be load bearing. The wheel size indicia 502 may be of any font, decorative form, size, or stylistic design.

A center cap 515 attachable to the wheel W may have wheel size indicia 517 of the same design as the size indicia 502 disposed on the member 500 and may be provided for design continuity of the wheel accessory 500. Member 500 may have wheel size indicia disposed on the member 500 in a manner not requiring spokes, such as when member 500 is a wheel cover.

The wheel components can be fabricated from a variety of materials, including, but not limited to, steel, magnesium, aluminum, and alloys of the same. Additionally, thermoplastics and/or composite materials may be used.

It is to be understood that the present invention is not limited to the embodiments described above, but encompasses any and all embodiments within the scope of the following claims.

I claim:

1. A wheel with size indicating members, comprising:
a wheel rim;
a center section disposed concentrically inside the wheel rim;
a hub disposed in an axial center of the center section;
at least one size indicating member disposed in rigid mechanical contact with the wheel rim and with some portion of the center section, the at least one member extending between the hub and the wheel rim and being configured to substantially indicate at least one Arabic numeral representing a wheel diameter of the wheel rim;
a plurality of lug holes disposed in the center section radially about the hub to provide mounting points for mounting the wheel on a vehicle; and
a cap removably attached to the center section, the cap having indicia completing any missing components of the at least one Arabic numeral.

2. The wheel with size indicating members according to claim 1, wherein the at least one size indicating member is shaped substantially in the form of the at least one Arabic numeral.

3. The wheel with size indicating members according to claim 1, wherein at least one recess is disposed in the at least one size indicating member, the at least one recess substantially forming the at least one Arabic numeral.

4. The wheel with size indicating members according to claim 1, wherein an extrusion is disposed on the at least one size indicating member, the extrusion being formed substantially in the shape of the at least one Arabic numeral.

5. The wheel with size indicating members according to claim 1, wherein the at least one Arabic numeral is embossed on the at least one size indicating member.

6. The wheel with size indicating members according to claim 1, wherein the at least one Arabic numeral comprises a decal on the at least one size indicating member.

7. The wheel with size indicating members according to claim 1, wherein the indicia on the cap is extruded from the cap.

8. The wheel with size indicating members according to claim 1, wherein the indicia on the cap is embossed in the cap.

9. The wheel with size indicating members according to claim 1, wherein the indicia on the cap comprises a decal on the cap.

10. The wheel with size indicating members according to claim 1, wherein the wheel is fabricated from a metal alloy.

11. The wheel with size indicating members according to claim 1, wherein the size indicating members are fabricated from a composite material.

12. The wheel with size indicating members according to claim 1, wherein the size indicating members are fabricated from a thermoplastic material.

13. A wheel accessory comprising:
a member adapted for attachment to a wheel of a vehicle so that the member is readily visible when the wheel is in a normal configuration on a vehicle; and
an Arabic number wheel size indicium disposed on the member so that the Arabic numeric wheel size indicium is readily visible when the wheel is in a normal configuration on the vehicle.

14. The wheel accessory according to claim 13, wherein the member has a central annular hub and a plurality of spokes extending therefrom, the wheel size indicia being disposed on the spokes, the central annular hub being attached to a central hub portion of the wheel.

15. The wheel accessory according to claim 14, further comprising bearings mounted on an inside circumferential portion of the central annular hub to enable the member to spin freely within the wheel.

16. The wheel accessory according to claim 13, further comprising a center cap adapted for attachment to the wheel, the center cap having wheel size indicia thereon.
